(19) United States
(12) Patent Application Publication
(10) Pub. No.: US 2025/0278971 A1
(43) Pub. Date: Sep. 4, 2025

(54) PAPER SHEET HANDLING APPARATUS AND CONTROL METHOD OF PAPER SHEET HANDLING APPARATUS

(71) Applicants: FUJITSU FRONTECH LIMITED, Tokyo (JP); Fujitsu Frontech Systems Limited, Maebashi-shi (JP)

(72) Inventors: Kazuyuki Shionoya, Inagi (JP); Shingo Amino, Inagi (JP)

(73) Assignees: FUJITSU FRONTECH LIMITED, Tokyo (JP); Fujitsu Frontech Systems Limited, Maebashi-shi (JP)

(21) Appl. No.: 19/210,511

(22) Filed: May 16, 2025

Related U.S. Application Data
(63) Continuation of application No. PCT/JP2022/043254, filed on Nov. 22, 2022.

(51) Int. Cl. G07D 11/175; G07D 11/20

(52) U.S. Cl. CPC G07D 11/175; G07D 11/20

(57) ABSTRACT

A paper sheet handling apparatus includes a conveyance path configured to convey a paper sheet and a wind-up drum around which a paper sheet is winded, and includes an accommodating section configured to accommodate a paper sheet conveyed by the conveyance path, by winding the paper sheet around the wind-up drum, a drive mechanism configured to drive the conveyance path, and a controller configured to control the drive mechanism. The conveyance path includes an arc-shaped pathway on which the conveyance path is curved along a conveyance direction of a paper sheet. The controller corrects a curl generated in the paper sheet by the wind-up drum, by curving the paper sheet in a direction opposite to the curl, by controlling the drive mechanism to feed a paper sheet discharged from the accommodating section, to the arc-shaped pathway, and reciprocate the paper sheet along the arc-shaped pathway.

### CROSS-REFERENCE TO RELATED APPLICATION

This application is a continuation of International Application No. PCT/JP2022/043254, filed on Nov. 22, 2022, the entire contents of which are incorporated herein by reference.

### FIELD

The embodiment discussed herein is related to a paper sheet handling apparatus and a control method of a paper sheet handling apparatus.

### BACKGROUND

As a paper sheet handling apparatus, a banknote handling apparatus such as an automated teller machine, for example, has been known. The banknote handling apparatus of this type includes an accommodating section that accommodates banknote, and some accommodating sections accommodate banknotes by winding the banknotes around the circumferential surface of a wind-up drum.

Patent Literature 1: WO 2017/203714 A

Because banknote accommodated in the accommodating section of the above-described banknote handling apparatus is maintained in a state of being winded around the wind-up drum, a curl tends to be generated along a circumferential direction of the wind-up drum. Thus, there is a problem that banknote, which is discharged from the accommodating section at the time of withdrawal to the user, is conveyed in a rolled-up state. In a case where banknote having a curl is fed to a withdrawing port, for example, there is a concern that banknote fed to the withdrawing port following banknote having a curl that is fed to the withdrawing port earlier fails to smoothly overlap the leading banknote, and the banknotes collide with each other, and the banknote having a curl is pushed out from the withdrawing port to the outside, and drops.

### SUMMARY

According to an aspect of an embodiment, a paper sheet handing apparatus includes: a conveyance path that is configured to convey a paper sheet; an accommodating section that includes a wind-up drum around which a paper sheet is winded, and is configured to accommodate a paper sheet conveyed by the conveyance path, by winding the paper sheet around the wind-up drum; a drive mechanism that is configured to drive the conveyance path; and a controller that is configured to control the drive mechanism, wherein the conveyance path includes an arc-shaped pathway on which the conveyance path is curved along a conveyance direction of a paper sheet, and the controller corrects a curl, which is generated in the paper sheet, by the wind-up drum, by curving the paper sheet in a direction opposite to the curl, by controlling the drive mechanism to feed a paper sheet, which is discharged from the accommodating section, to the arc-shaped pathway, and reciprocate the paper sheet along the arc-shaped pathway.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an entire banknote handling apparatus of an embodiment;

FIG. 2 is a side view illustrating an accommodating section in an embodiment;

FIG. 3 is a side view illustrating an accommodating section in an embodiment;

FIG. 4 is a longitudinal sectional view illustrating a main part of a conveyance path in an embodiment;

FIG. 5 is a side view illustrating an arc-shaped pathway of a conveyance path in an embodiment;

FIG. 6 is a flowchart for explaining control processing to be executed when banknote is discharged from an accommodating section in an embodiment;

FIG. 7 is a schematic diagram for explaining a correction operation of a curl of banknote in an embodiment; and

FIG. 8 is a schematic diagram for explaining a correction operation of a curl of banknote in an embodiment.

### DESCRIPTION OF EMBODIMENTS

Hereinafter, an embodiment of a paper sheet handling apparatus and a control method of a paper sheet handling apparatus that are disclosed by the subject application, will be described in detail based on the drawings. In addition, the paper sheet handling apparatus and the control method of the paper sheet handling apparatus that are disclosed by the subject application, are not limited by the following embodiment.

### Configuration of Banknote Handling Apparatus

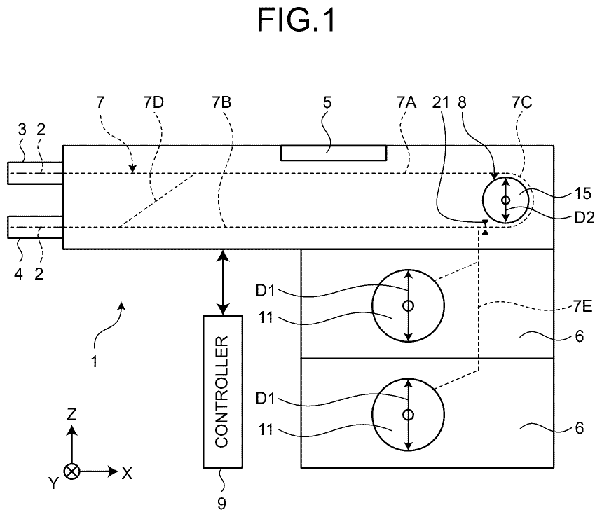

FIG. 1 is a schematic diagram illustrating an entire banknote handling apparatus of an embodiment. As illustrated in FIG. 1, a banknote handling apparatus 1 according to an embodiment includes a depositing section 3 via which the user deposits banknote 2, a withdrawing section 4 that withdraws the banknote 2 to the user, a distinguishing section 5 that distinguishes the banknote 2, which is conveyed from the depositing section 3, and a plurality of accommodating sections (circulating sections) 6 that circulates the banknote 2 by accommodating the banknote 2, which is conveyed from the distinguishing section 5, and withdrawing the banknote 2 to the withdrawing section 4. Further, the banknote handling apparatus 1 includes a conveyance path 7 that conveys the banknote 2 between the components 3 to 6, a drive mechanism 8 that drives the conveyance path 7, and a controller 9 that controls the drive mechanism 8.

For the sake of explanation, when the banknote handling apparatus 1 is viewed from a front side on which the depositing section 3 and the withdrawing section 4 are positioned in FIG. 1, a width direction of the banknote handling apparatus 1 will be referred to as an X direction, a front-back direction of the banknote handling apparatus 1 will be referred to as a Y direction, and an up-down direction of the banknote handling apparatus 1 will be referred to as a Z direction. Also, in the drawings following FIG. 1, the X, Y, and Z directions are illustrated similarly to FIG. 1. Further, in the present embodiment, the banknote 2 is used as an example of a paper sheet, but a paper sheet is not limited to the banknote 2. Examples of paper sheets include valuable securities such as bill, check, a gift ticket, various corporation securities, and stock certificate.

The depositing section 3 and the withdrawing section 4 are adjacently arranged on the front side of the banknote handling apparatus 1. The withdrawing section 4 is formed in such a manner that the banknote 2, which is conveyed one by one from each of the accommodating sections 6, is collected to the withdrawing port. The distinguishing section 5 distinguishes the authenticity of the banknote 2, which is conveyed from the depositing section 3. Each of the accommodating sections 6 includes a wind-up drum 11 around which the banknote 2 is winded and accommodated, and the banknote 2 is accommodated in each of the accommodating sections 6 for each denomination.

Then, the controller 9 of the banknote handling apparatus 1 feeds the banknote 2, which is discharged from the accommodating section 6, to an arc-shaped pathway 7C to be described later that is included in the conveyance path 7, and controls the drive mechanism 8 to reciprocate the banknote 2 along the arc-shaped pathway 7C. The banknote 2 is thereby curved on the arc-shaped pathway 7C in a direction opposite to a curl, which is generated in the banknote 2 due to the wind-up drum 11 of the accommodating section 6, and the curl is corrected on the arc-shaped pathway 7C. In addition, the direction opposite to the curl refers to a direction in which the banknote 2 is curved into an approximately symmetrical shape to a curve shape of the curl of the banknote 2. As the controller 9 of the present embodiment, a control circuit of a control substrate, which is provided inside the banknote handling apparatus 1, is used, but the controller 9 is not limited to this, and an external computer, which is connected with the banknote handling apparatus 1, may be used.

### Accommodating Section

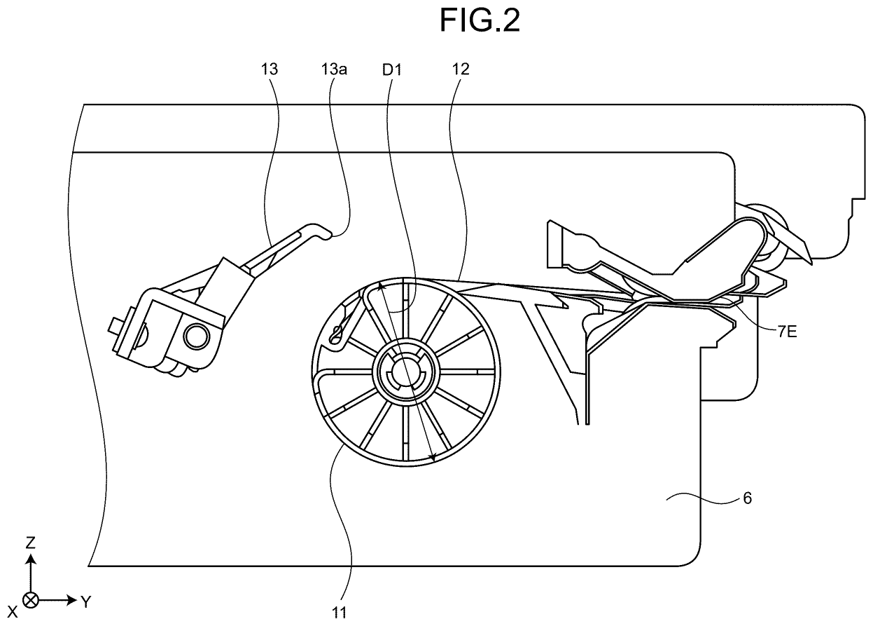

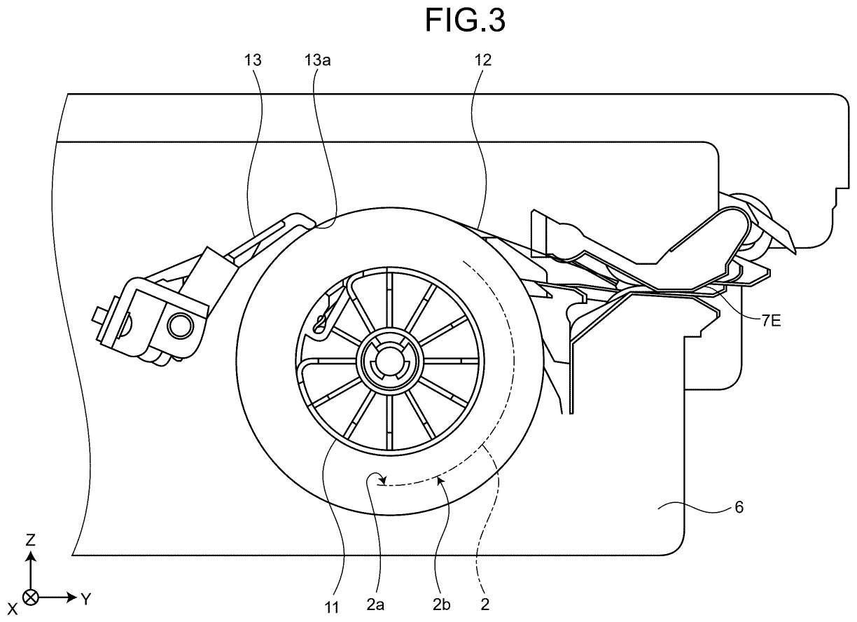

FIGS. 2 and 3 are side views illustrating the accommodating section 6 in an embodiment. FIG. 2 illustrates a state in which the banknote 2 is not winded around the wind-up drum 11, and a state in which an external diameter of the wind-up drum 11 is the smallest. FIG. 3 illustrates a state in which the banknote 2 is not winded around the wind-up drum 11, and a state in which an external diameter (winding diameter) of the wind-up drum 11, on which the banknote 2 is accommodated, is the largest.

As illustrated in FIGS. 2 and 3, the accommodating section 6 accommodates the banknote 2 by winding the banknote 2, which is conveyed by the conveyance path 7, one by one around the circumferential direction of the wind-up drum 11 together with a belt-like film (tape) 12, which is supplied from a supply reel (not illustrated). The banknote 2 having a rectangular external form is winded in a direction in which a long side of the banknote 2 goes along the circumferential direction of the wind-up drum 11, for example. Accordingly, a curl, which is curved along a long side direction in which the banknote 2 is winded in the circumferential direction of the wind-up drum 11, is generated in the banknote 2.

In addition, the embodiment is not intended to limit a direction in which a curl is generated in the banknote 2. The banknote may be winded along a direction in which a short side of the banknote 2 goes along the circumferential direction of the wind-up drum 11, and the present embodiment may be applied to correct a curl, which is curved in the short side direction of the banknote 2.

Further, in the accommodating section 6, a detection lever 13, which detects that a winding diameter of the wind-up drum 11 getting gradually larger in accordance with the accommodation of the banknote 2 has become the largest, is provided on an outer circumferential side of the wind-up drum 11. The detection lever 13 is rotatably supported on a support shaft, and is rotated by a leading end 13a having contact with the outer circumferential surface of the wind-up drum 11 (refer to FIG. 2). By detecting the rotation of the detection lever 13 using a sensor (not illustrated, the controller 9 controls the accommodating section 6 to stop the accommodation of the banknote 2 on the wind-up drum 11 when the winding diameter of the wind-up drum 11 becomes the largest.

### Conveyance Path

The conveyance path 7 includes a first linear pathway 7A, which extends from the depositing section 3 in the Y direction, a second linear pathway 7B, which extends from the withdrawing section 4 in the Y direction, the arc-shaped pathway 7C, which links one end of the first linear pathway 7A and one end of the second linear pathway 7B, a communication pathway 7D, which connects the depositing section 3 side of the first linear pathway 7A and the withdrawing section 4 side of the second linear pathway 7B, and an accommodation pathway 7E, which extends from the second linear pathway 7B side on the arc-shaped pathway 7C to each of the accommodating section 6.

The first linear pathway 7A and the second linear pathway 7B are provided in parallel to each other. The distinguishing section 5 is arranged at some midpoint on the first linear pathway 7A. The arc-shaped pathway 7C is formed into a U-shape by the conveyance path 7 being curved along a conveyance direction of the banknote 2.

The arc-shaped pathway 7C is a pathway through which the banknote 2 passes when the banknote 2, which is conveyed from the depositing section 3 along the first linear pathway 7A, is accommodated in the accommodating section 6. Further, after the banknote 2, which is discharged from the accommodating section 6, is conveyed to the first linear pathway 7A through the arc-shaped pathway 7C, when the banknote 2 is conveyed from the first linear pathway 7A to the second linear pathway 7B, the banknote 2 passes through the communication pathway 7D, and the banknote 2 is conveyed to the withdrawing section 4, which will be described in detail later.

### Drive Mechanism

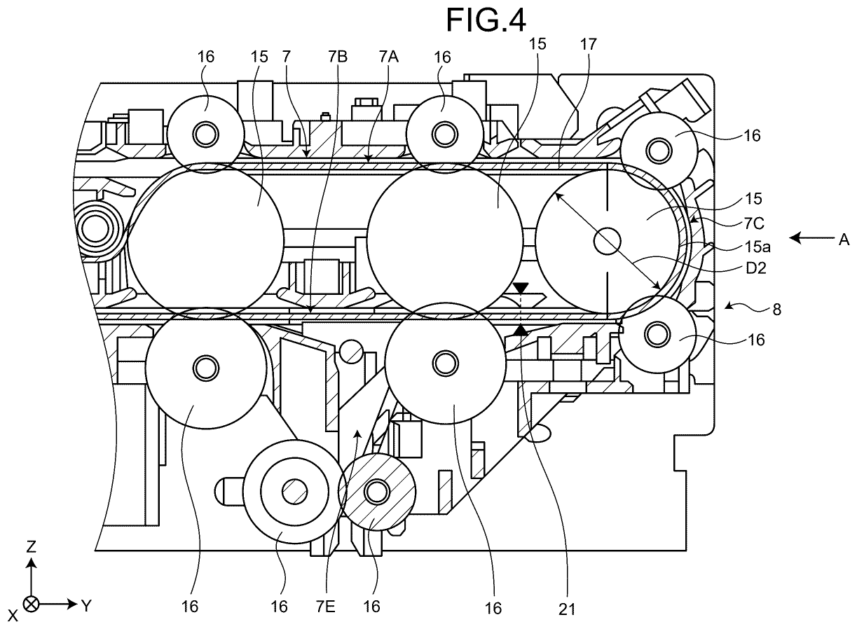

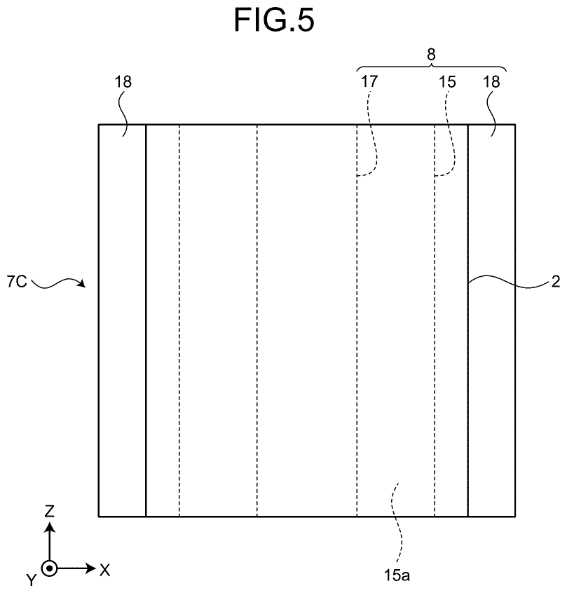

FIG. 4 is a longitudinal sectional view illustrating a main part of the conveyance path 7 in an embodiment. FIG. 5 is a side view illustrating the arc-shaped pathway 7C of the conveyance path 7 in an embodiment. FIG. 5 is a side view of the arc-shaped pathway 7C viewed from an A direction in FIG. 4.

As illustrated in FIGS. 4 and 5, the drive mechanism 8 includes a plurality of pulleys 15 to be rotated by a motor (not illustrated), a plurality of pinch rollers 16, which is arranged to have contact with the respective pulleys 15, a conveyance belt 17 (timing belt), which conveys the banknote 2 along the conveyance path 7 by being driven by the pulley 15, and a guide member 18, which guides the movement of the banknote 2 to be fed with being pinched between the conveyance belt 17 and the pinch roller 16 (refer to FIG. 5).

On the arc-shaped pathway 7C, a single pulley 15, on which an outer circumferential surface 15a, which extends along the entire arc-shaped pathway 7C, is formed, is arranged. Thus, because the banknote 2 can be curved along the outer circumferential surface 15a of the pulley 15 when the banknote 2 passes through the arc-shaped pathway 7C, a function of correcting a curl on the arc-shaped pathway 7C is effectively obtained. As illustrated in FIG. 5, the conveyance belt 17 is stretched over along the center in the width direction (the X direction) of the outer circumferential surface 15a of the pulley 15. The guide members 18 are arranged on both sides in the width direction (the X direction) of the pulley 15.

As illustrated in FIGS. 1 and 4, an optical sensor 21, which detects the banknote 2 passing through the conveyance path, 7 is provided near the end on the second linear pathway 7B side of the arc-shaped pathway 7C of the conveyance path 7, for example. As the optical sensor 21, for example, a transmissive optical sensor is used, and a light-emitting element, which emits detection light, and a light receiving element, which receives detection light from the light-emitting element, are arranged at facing positions in the up-down direction (the Z direction) of the conveyance path 7.

The optical sensor 21 is electrically connected with the controller 9, and transmits a detection signal of the banknote 2 to the controller 9. By controlling the drive mechanism 8 based on a detection result of the optical sensor 21, the controller 9 reciprocates the banknote 2 between both ends of the arc-shaped pathway 7C of the conveyance path 7 a predetermined number of times. The controller 9 determines the number of times the banknote 2 is to be reciprocated on the arc-shaped pathway 7C, based on the number of times the banknote 2 passes through the optical sensor 21. Further, the controller 9 moves the banknote 2 having passed through the optical sensor 21, from one end side (the second linear pathway 7B side) of the arc-shaped pathway 7C to the other end side (the first linear pathway 7A side) for a predetermined time, and then stops the movement of the banknote 2 on the other end side of the arc-shaped pathway 7C, and returns the banknote 2 to one end side of the arc-shaped pathway 7C, thereby reciprocating the banknote 2. Further, the controller 9 is electrically connected with the drive mechanism 8 or the accommodating section 6, and controls the drive mechanism 8 to feed the banknote 2 from the accommodating section 6 to the arc-shaped pathway 7C when the banknote 2 is discharged from the accommodating section 6.

Relationship between Curvature of Wind-Up Drum and Curvature of Pulley of Arc-Shaped Pathway

As illustrated in FIGS. 1 and 2, a ratio (D2/D1) of a diameter D2 of the pulley 15 with respect to a diameter D1 of the wind-up drum 11, is 0.9 or more and 1.1 or less. Here, as illustrated in FIG. 2, the diameter D1 of the wind-up drum 11 refers to a diameter of the wind-up drum 11 itself that is measured when the banknote 2 is not winded.

In the present embodiment, as an example, the wind-up drum 11 is formed to have the diameter D1 of about 40 [mm], and the pulley 15 is formed to have the diameter D2 of about 36 [mm], and the ratio (D2/D1) of the diameter D2 of the pulley 15 with respect to the diameter D1 of the wind-up drum 11, is set to about (36/40)=0.9. In an embodiment, as an example, the diameter D1 of the wind-up drum 11 is set to a diameter larger than the diameter D2 of the pulley 15, but magnitude relation of the diameter D1 of the wind-up drum 11 and the diameter D2 of the pulley 15, may be opposite to that in the embodiment. In addition, as illustrated in FIG. 3, a diameter of the wind-up drum 11 becomes about 65 [mm] when it becomes the largest by the banknote 2 being winded therearound.

As described above, when the banknote 2 is reciprocated along an arc-shaped pathway 15C, the banknote 2 is curved along the outer circumferential surface 15a of the pulley 15. At this time, by the diameter D1 of the wind-up drum 11 and the diameter D2 of the pulley 15 satisfying the above-described numerical value range, by the outer circumferential surface 15a of the pulley 15, the banknote 2 is curved at a curvature equivalent to the curvature of the curl of the banknote 2 that is generated by the wind-up drum 11, in a direction opposite to the curl of the banknote 2, and an opposite-direction curl is prevented from newly generated by the pulley 15 at the time of correction. Thus, because a function of correcting the banknote 2 having a curl to flat, can be enhanced, it is possible to appropriately correct a curl generated by the wind-up drum 11.

### Correction Operation of Curl in Banknote Withdrawing

In the banknote handling apparatus 1 having the above configuration, a correction operation of a curl generated in the banknote 2, which is conveyed from the accommodating section 6 to the withdrawing section 4, will be described.

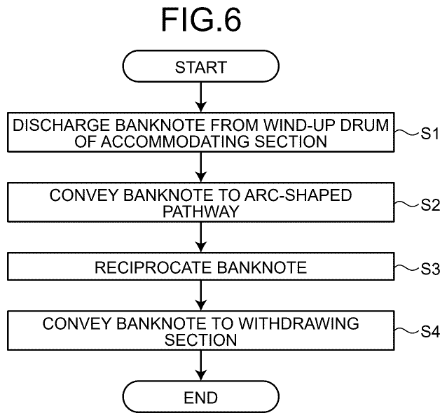

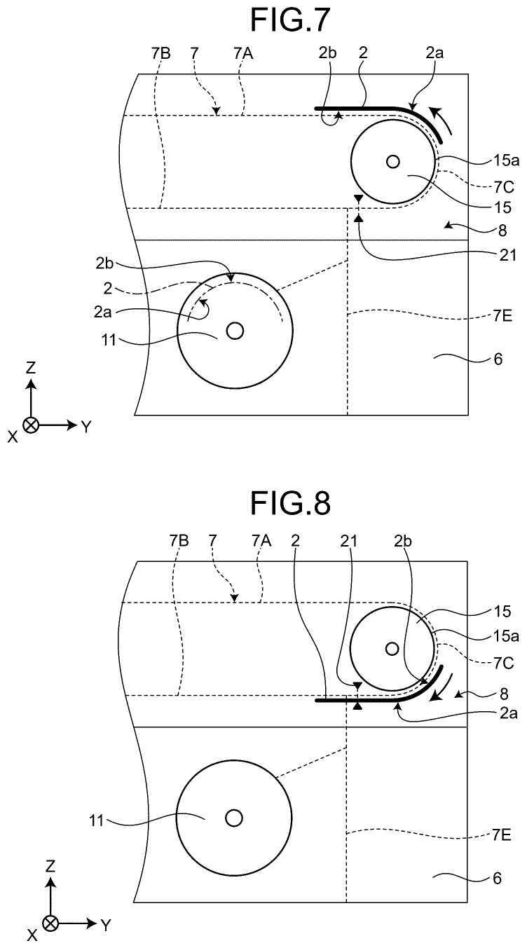

FIG. 6 is a flowchart for explaining control processing to be executed when the banknote 2 is discharged from the accommodating section 6. FIGS. 7 and 8 are schematic diagrams for explaining a correction operation of a curl of the banknote 2 in an embodiment, and are schematic diagrams illustrating the banknote 2 to be reciprocated between both ends of the arc-shaped pathway 7C.

As illustrated in FIG. 6, when withdrawing the banknote 2 to the user, the banknote handling apparatus 1 discharges the banknote 2 one by one from the wind-up drum 11 of the accommodating section 6 (Step S1). At this time, the controller 9 conveys the banknote 2, which is discharged from the accommodating section 6, to the arc-shaped pathway 7C of the conveyance path 7, by controlling the drive mechanism 8 (Step S2). Subsequently, by controlling the drive mechanism 8 based on a detection result of the optical sensor 21, which is arranged near the end of the arc-shaped pathway 7C, the controller 9 reciprocates the banknote 2 between both ends (i.e., upper end and lower end) of the arc-shaped pathway 7C as illustrated in FIGS. 7 and 8 (Step S3).

At this time, as illustrated in FIGS. 3 and 7, a paper surface 2a of the banknote 2 on an inner circumferential side when the banknote 2 is winded around the wind-up drum 11, is positioned on an outer circumferential side of the arc-shaped pathway 7C, and a paper surface 2b on an outer circumferential side when the banknote 2 is winded around the wind-up drum 11, is positioned on an inner circumferential side of the arc-shaped pathway 7C, (i.e.,) has contact with the outer circumferential surface 15a of the pulley 15. Thus, the banknote 2 to be reciprocated on the arc-shaped pathway 7C, is curved in a direction opposite to the curl, which is generated on the wind-up drum 11, and the curl is corrected.

As illustrated in FIGS. 6, 7, and 8, the controller 9 repeats reciprocation on the arc-shaped pathway 7C a predetermined number of times such as, for example, about five times to ten times, controls conveying the banknote 2 with a corrected curl from the arc-shaped pathway 7C to the first linear pathway 7A, controls conveying the banknote 2 from the first linear pathway 7A to the second linear pathway 7B through the communication pathway 7D, and controls conveying the banknote 2 to the withdrawing section 4 (Step S4).

In an embodiment, a correction operation of a curl of the banknote 2 is performed using the U-shaped arc-shaped pathway 7C that links the first linear pathway 7A and the second linear pathway 7B. In other words, by using the arc-shaped pathway 7C through which the banknote 2 passes when the banknote 2 is accommodated in the accommodating section 6, a correction operation of a curl of the banknote 2 is performed. By using an existing arc-shaped pathway 7C in this manner, it is possible to avoid the elongation of the conveyance path 7 without adding a pathway dedicated for correction, to the conveyance path 7, and prevent upsizing of the entire banknote handling apparatus 1. In addition, because it is possible to easily ensure a curvature of the arc-shaped pathway 7C at an equal level to a curvature of the wind-up drum 11, it is possible to appropriately perform a correction operation of a curl, which is generated by the wind-up drum 11.

By the above-described control processing, the controller 9 performs a correction operation of a curl on all the banknotes 2 one by one, when the banknote 2 is discharged from each of the accommodating section 6. Accordingly, the banknote 2 with a corrected curl is fed to the withdrawing section 4 one by one, the banknotes 2 are smoothly overlapped and withdrawn without colliding with each other at the withdrawing port.

Further, the controller 9 in an embodiment performs a correction operation of a curl on all the banknotes 2, which are discharged from each of the accommodating section 6, by the above-described control processing, but the configuration is not limited to this. The controller 9 may perform control in such a manner as to perform a correction operation only in a case where a plurality of the banknotes 2 is withdrawn from the accommodating section 6 to the withdrawing section 4, for example, or may determine whether or not to perform a correction operation, depending on the position of the banknote 2, which is winded around the wind-up drum 11 (position in a radial direction of the wind-up drum 11) and perform a correction operation only on arbitrary banknote 2.

### Another Correction Operation

A curvature of a curl, which is generated in the banknote 2 that is winded around the wind-up drum 11, changes in accordance with a difference in a position in the radial direction of the wind-up drum 11 between the inner circumferential side and the outer circumferential side of the wind-up drum 11. Thus, a curvature of a curl, which is generated in the banknote 2 on the inner circumferential side, is smaller as compared with that on the outer circumferential side of the wind-up drum 11, and by the banknote 2, which is winded on the inner circumferential side, receiving pressing force from the banknote 2 winded on the outer circumferential side, a curl correction tends to become difficult. Thus, when correcting a curl of the banknote 2, which is winded on the inner circumferential side of the wind-up drum 11, the controller 9 can appropriately correct a curl difficult to be corrected, by increasing the number of times the banknote 2 is reciprocated on the arc-shaped pathway 7C (the number of times a correction operation is performed).

Accordingly, when the banknote 2 is discharged from the accommodating section 6, the controller 9 may control the drive mechanism 8 in such a manner as to increase the number of times the banknote 2, which is discharged from the accommodating section 6, is reciprocated along the arc-shaped pathway 7C, when an external diameter of the wind-up drum 11, around which the banknote 2 is winded, becomes a predetermined diameter or less.

In this case, the detection of an external diameter of the wind-up drum 11, around which the banknote 2 is winded, may be performed by the calculation of an external diameter of the wind-up drum 11 by counting the number of the banknote 2 accommodated in the accommodating section 6, for example, and the controller 9 may make determination based on a calculation result. Instead of counting the number of the banknote 2, the accommodating section 6 may include a detector (not illustrated), which detects an external diameter of the wind-up drum 11 that changes in accordance with the discharge of the banknote 2, and may detect an external diameter of the wind-up drum 11 using the above-described detection lever 13 or the like.

Further, the controller 9 may control the drive mechanism 8 in such a manner as to pause the banknote 2 only by a predetermined time such as several seconds, for example, on the midway on the arc-shaped pathway 7C during the reciprocation of the banknote 2. That is, the controller 9 pauses all the banknotes 2, which are discharged from the accommodating section 6, one by one, during the reciprocation on the arc-shaped pathway 7C.

In this case, for example, the banknote 2 is paused in such a manner that a center in a long side direction (conveyance direction) of the banknote 2 is positioned at the center on the arc-shaped pathway 7C. With this configuration, because it becomes possible to keep a state in which the banknote 2, in which a curl is generated, is curved in a direction opposite to the curl over the entire banknote 2 in the long side direction, for a predetermined time on the arc-shaped pathway 7C, a function of correcting a curl is enhanced. Further, as a timing at which the banknote 2 is paused on the midway on the arc-shaped pathway 7C, an operation may shift to an operation of performing reciprocation a predetermined number of times after performing operation of pausing the banknote 2 only by about several seconds once, or a predetermined number of times of reciprocation and a pause may be alternately repeated.

### Control Method of Banknote Handling Apparatus

A control method of the banknote handling apparatus 1 of an embodiment corrects a curl by curving the banknote 2 in a direction opposite to a curl, which is generated in the banknote 2 by the wind-up drum 11, by controlling the drive mechanism 8 by the controller 9 in such a manner as to feed the banknote 2, which is discharged from the accommodating section 6, to the arc-shaped pathway 7C, and reciprocate the banknote 2 along the arc-shaped pathway 7C. In addition, the control method of the banknote handling apparatus 1 may be used by a program that causes a computer to execute the control method, a recording medium such as an optical disk on which the program is recorded.

### Effect of Embodiment

As described above, the banknote handling apparatus 1 according to an embodiment includes the accommodating section 6 that accommodates the banknote 2, which is conveyed by the conveyance path 7, by winding the banknote 2 around the wind-up drum 11, the drive mechanism 8 that drives the conveyance path 7, and the controller 9 that controls the drive mechanism 8, and the conveyance path 7 includes the arc-shaped pathway 7C on which the conveyance path 7 is curved along the conveyance direction of the banknote 2. The controller 9 corrects a curl by curving the banknote 2 on the arc-shaped pathway 7C in a direction opposite to a curl, which is generated in the banknote 2 by the wind-up drum 11, by controlling the drive mechanism 8 in such a manner as to feed the banknote 2, which is discharged from the accommodating section 6, to the arc-shaped pathway 7C, and reciprocate the banknote 2 along the arc-shaped pathway 7C. With this configuration, when the banknote 2 is discharged from the accommodating section 6, it is possible to discharge the banknote 2 after correcting a curl, which is generated due to the wind-up drum 11 of the accommodating section 6. As a result, when the banknote 2 is conveyed from the wind-up drum 11 of the accommodating section 6 from the withdrawing section 4, it is possible to prevent the banknotes 2, which are fed to a withdrawing port, from colliding with each other at the withdrawing port of the withdrawing section 4, and dropping to the outside from the withdrawing port, and prevent the loss of the fallen banknote 2, or the like.

Further, the drive mechanism 8 of the banknote handling apparatus 1 of an embodiment includes a single pulley 15 on which the outer circumferential surface 15a, which extends along the entire arc-shaped pathway 7C, is formed. With this configuration, because the banknote 2 can be curved along the outer circumferential surface 15a of the pulley 15 when the banknote 2 passes through the arc-shaped pathway 7C, a function of correcting a curl on the arc-shaped pathway 7C is effectively obtained.

Further, in the banknote handling apparatus 1 of an embodiment, the conveyance path 7 includes the first linear pathway 7A and the second linear pathway 7B, which are provided parallel to each other, and the arc-shaped pathway 7C is formed into a U-shape that links the first linear pathway 7A and the second linear pathway 7B. With this configuration, by using an existing arc-shaped pathway 7C on the conveyance path 7, it is possible to avoid the elongation of the conveyance path 7 without adding a pathway, which is dedicated for correction, to the conveyance path 7, and prevent upsizing of the entire banknote handling apparatus 1. In addition, because it is possible to easily ensure a curvature of the arc-shaped pathway 7C at an equal level to a curvature of the wind-up drum 11, it is possible to appropriately perform a correction operation of a curl, which is generated by the wind-up drum 11.

Further, in the banknote handling apparatus 1 of an embodiment, the arc-shaped pathway 7C is a pathway through which the banknote 2 passes when the banknote 2 is accommodated in the accommodating section 6. With this configuration, by using an existing arc-shaped pathway 7C on the conveyance path 7, it is possible to avoid the elongation of the conveyance path 7 without adding a pathway, which is dedicated for correction, to the conveyance path 7, and prevent upsizing of the entire banknote handling apparatus 1. In addition, because it is possible to easily ensure a curvature of the arc-shaped pathway 7C at an equal level to a curvature of the wind-up drum 11, it is possible to appropriately perform a correction operation of a curl, which is generated by the wind-up drum 11.

Further, in the banknote handling apparatus 1 of an embodiment, a ratio (D2/D1) of a diameter D2 of the pulley 15 with respect to a diameter D1 of the wind-up drum 11, is 0.9 or more and 1.1 or less. With this configuration, by the outer circumferential surface 15a of the pulley 15, the banknote 2 is curved at a curvature equivalent to the curvature of the curl of the banknote 2, which is generated by the wind-up drum 11, in a direction opposite to the curl of the banknote 2, and an opposite-direction curl is prevented from newly generated by the pulley 15 at the time of correction. Thus, because a function of correcting the banknote 2 having a curl to flat, can be enhanced, it is possible to appropriately correct a curl, which is generated by the wind-up drum 11.

Further, in the banknote handling apparatus 1 of an embodiment, when the banknote 2 is discharged from the accommodating section 6, the controller 9 may control the drive mechanism 8 in such a manner as to increase the number of times the banknote 2, which is discharged from the accommodating section 6, is reciprocated along the arc-shaped pathway 7C, when an external diameter (winding diameter) of the wind-up drum 11, around which the banknote 2 is winded, becomes a predetermined diameter or less. With this configuration, it becomes possible to appropriately correct a curl difficult to be corrected that is generated on the inner circumferential side as compared with the outer circumferential side of the wind-up drum 11.

Further, in the banknote handling apparatus 1 of an embodiment, the controller 9 controls the drive mechanism 8 in such a manner as to pause the banknote 2 only by a predetermined time on the midway on the arc-shaped pathway 7C during the reciprocation of the banknote 2. With this configuration, because it becomes possible to keep a state in which the banknote 2, in which a curl is generated, is curved in a direction opposite to the curl over the entire banknote 2 in the conveyance direction (for example, long side direction), for a predetermined time on the arc-shaped pathway 7C, a function of correcting a curl is enhanced.

In addition, the banknote handling apparatus 1 of an embodiment may include a temporal holding section (not illustrated), which temporarily accommodates the banknote 2 under transaction processing that is conveyed from the depositing section 3, by winding the banknote 2 around the wind-up drum. In this case, when the banknote 2, which is accommodated in the temporal holding section, is conveyed to the withdrawing section 4, a curl of the banknote 2 may be corrected by the arc-shaped pathway 7C as in an embodiment, and an effect similar to the embodiment is obtained.

According to an aspect of a paper sheet handling apparatus disclosed by the subject application, when a paper sheet is discharged from an accommodating section, it is possible to discharge a paper sheet after correcting a curl generated due to a wind-up drum of the accommodating section.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A paper sheet handling apparatus comprising:
a conveyance path that is configured to convey a paper sheet;
an accommodating section that includes a wind-up drum around which a paper sheet is winded, and is configured to accommodate a paper sheet conveyed by the conveyance path, by winding the paper sheet around the wind-up drum;
a drive mechanism that is configured to drive the conveyance path; and
a controller that is configured to control the drive mechanism,
wherein the conveyance path includes an arc-shaped pathway on which the conveyance path is curved along a conveyance direction of a paper sheet, and
the controller corrects a curl, which is generated in the paper sheet, by the wind-up drum, by curving the paper sheet in a direction opposite to the curl, by controlling the drive mechanism to feed a paper sheet, which is discharged from the accommodating section, to the arc-shaped pathway, and reciprocate the paper sheet along the arc-shaped pathway.

2. The paper sheet handling apparatus according to claim 1,
wherein the drive mechanism includes a single pulley on which an outer circumferential surface extending along the entire arc-shaped pathway is formed.

3. The paper sheet handling apparatus according to claim 2,
wherein the drive mechanism includes a single pulley on which an outer circumferential surface extending along the entire arc-shaped pathway is formed.

4. The paper sheet handling apparatus according to claim 1,
wherein the conveyance path includes a first linear pathway and a second linear pathway, which are provided in parallel to each other, and
the arc-shaped pathway is formed into a U-shape that links the first linear pathway and the second linear pathway.

5. The paper sheet handling apparatus according to claim 2,
wherein the conveyance path includes a first linear pathway and a second linear pathway, which are provided in parallel to each other, and
the arc-shaped pathway is formed into a U-shape that links the first linear pathway and the second linear pathway.

6. The paper sheet handling apparatus according to claim 1,
wherein the arc-shaped pathway is a pathway through which a paper sheet passes when the paper sheet is accommodated in the accommodating section.

7. The paper sheet handling apparatus according to claim 2,
wherein a ratio of a diameter of the pulley with respect to a diameter of the wind-up drum is 0.9 or more and 1.1 or less.

8. The paper sheet handling apparatus according to claim 1,
wherein, when a paper sheet is discharged from the accommodating section, the controller controls the drive mechanism in such a manner as to increase the number of times a paper sheet, which is discharged from the accommodating section, is reciprocated along the arc-shaped pathway, when an external diameter of the wind-up drum, around which a paper sheet is winded, becomes a predetermined diameter or less.

9. The paper sheet handling apparatus according to claim 8,
wherein the controller controls the drive mechanism in such a manner as to pause a paper sheet for a predetermined time on a midway on the arc-shaped pathway during the reciprocation of the paper sheet.

10. A control method of a paper sheet handling apparatus including: a conveyance path that is configured to convey a paper sheet; an accommodating section that includes a wind-up drum around which a paper sheet is winded, and is configured to accommodate a paper sheet conveyed by the conveyance path, by winding the paper sheet around the wind-up drum; a drive mechanism that is configured to drive the conveyance path; and a controller that is configured to control the drive mechanism, the conveyance path including an arc-shaped pathway on which the conveyance path is curved along a conveyance direction of a paper sheet, the control method comprising:
correcting a curl, which is generated in the paper sheet, by the wind-up drum by curving the paper sheet in a direction opposite to the curl, by controlling the drive mechanism by the controller to feed a paper sheet, which is discharged from the accommodating section, to the arc-shaped pathway, and reciprocate the paper sheet along the arc-shaped pathway.
